(19) United States
(12) Patent Application Publication
(10) Pub. No.: US 2016/0091104 A1
(43) Pub. Date: Mar. 31, 2016

(54) Methods and Apparatus for a Safety Valve

(71) Applicant: BKB Flow Controls, LLC, Scottsdale, AZ (US)

(72) Inventors: Matthew Stokeley Carroll, Las Vegas, NV (US); Mathew John Leis, Scottsdale, AZ (US); Jeremy Chey Martinjako, Flagstaff, AZ (US); Samuel James Stevenson, Phoenix (UK); Michael James Valacich, Tucson, AZ (US)

(73) Assignee: BKB Flow Controls, LLC, Scottsdale, AZ (US)

(21) Appl. No.: 14/261,305

(22) Filed: Apr. 24, 2014

(51) Int. Cl. F16K 17/38; F16K 31/00

(52) U.S. Cl. CPC F16K 17/383; F16K 31/002

(57) ABSTRACT

Methods and apparatus for a safety shutoff valve generally comprise a valve lever coupled to a pipe, a shifting mechanism coupled to the valve lever, which causes the valve lever to be biased to move to and stay in the closed position, a release bar to hold the valve lever in the open position, a release mechanism, and an actuator. The actuator is a nickel-titanium alloy wire. The release bar holds the valve lever in the open position, the release bar being held in place by the release mechanism coupled to it. The release mechanism is coupled to nickel-titanium alloy wire, which extends along the pipe away from the valve apparatus. When heated, by a fire, for example, the nickel-titanium alloy wire contracts, pulls the release mechanism away from the release bar, and allows the valve lever to automatically move to and remain in the closed position, cutting off the flow of oil, or other fire fuel, to the fire.

### BACKGROUND

Oil refinery and pipeline fires pose enormous risks to human life and resources. Therefore, ways to prevent or mitigate the duration and intensity of oil refinery and pipeline fires are valuable.

When a fire ignites, it needs fuel, heat, and oxygen in order to keep burning. In the case of oil pipelines or refineries, oil is an effective fuel for fires. Accordingly, if the fuel source can be cut off when a fire starts, there is much more of a chance to limit the duration and intensity of the fire.

Emergency safety shutoff valves are designed to cut off the fuel source in case of fire; they automatically close the valve when a fire is detected.

There are already-existing mechanical and electrical safety shutoff valves. Existing mechanical safety shutoff valves are not ideal because, as in U.S. Pat. No. 8,607,872, they require that the fire be directly located at the valve in order to activate the shutoff mechanism. If the fire is somewhere along the pipeline away from the valve, the safety valve will not be activated. Existing electrical safety shutoff valves are also not ideal because in the case of a conflagration, electricity is often compromised, which may disallow the activation of the valve shutoff mechanism. Also, electrical safety valve shutoff apparatuses are very expensive, and the entire apparatus must be replaced if it is activated.

So as to reduce the complexity and length of the Detailed Specification, and to fully establish the state of the art in certain areas of technology, Applicants herein expressly incorporate by reference all of the following materials identified in each numbered paragraph below.

U.S. Pat. No. 4,169,254, Kennedy et al., “Thermally activated emergency electric switch.” This reference describes a fusible link safety shutoff apparatus, in which excess heat deforms the fusible link, and cuts off the flow of electricity.

U.S. Pat. No. 8,607,872, Bugariu, “Fire prevention blow-out valve.” This reference describes a safety shutoff valve in an oil well, in which a triggering mechanism, which holds a plunger in the open configuration, melts when there is excess heat and releases a spring which plugs the valve with the plunger and stops oil flow.

Applicants believe that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), Applicants will amend the specification to expressly recite the essential material that is incorporated by reference as allowed by the applicable rules.

### SUMMARY

The present invention provides, among other things, a safety shutoff valve apparatus constructed around a valve lever coupled to a pipe. When there is a fire within or around a piping system, which the safety valve apparatus is monitoring, the heat will activate the safety shutoff mechanism and close the valve to stop the flow of oil or other fuel to the fire.

The safety valve apparatus may generally comprise a valve lever coupled to a pipe, a release bar which may be coupled to a foundation, a shifting mechanism which may be coupled to the valve lever, a release rod or release lever which may be held by a rod holder or fulcrum, respectively, and may be removably coupled to the release bar, and a nickel-titanium alloy wire, which is the actuator of the safety valve apparatus and may be coupled to the release rod or release lever. The wire extends along the pipe in a direction away from the valve apparatus. The safety valve apparatus may further comprise a protective casing enclosing the safety valve apparatus, a reset mechanism, a reset cap coupled to the release bar, and a spring adjacent to the reset cap. Embodiments of the current invention may comprise one or more of these components and still remain within the scope of the current invention.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of pre-AIA 35 U.S.C. §112, ¶6 and post-AIA 35 U.S.C. §112(f). Thus, the use of the words “function,” “means” or “step” in the Detailed Description or Description of the Drawings or claims is not intended to somehow indicate a desire to invoke the special provisions of pre-AIA 35 U.S.C. §112, ¶6 or post-AIA 35 U.S.C. §112(f), to define the invention. To the contrary, if the provisions of pre-AIA 35 U.S.C. §112, ¶6 or post-AIA 35 U.S.C. §112(f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of pre-AIA 35 U.S.C. §112, ¶6 or post-AIA 35 U.S.C. §112(f). Moreover, even if the provisions of pre-AIA 35 U.S.C. §112, ¶6 or post-AIA 35 U.S.C. §112(f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DETAILED DESCRIPTION and DRAWINGS, and from the CLAIMS.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts a perspective view of an embodiment of a safety valve apparatus and an extension of a pipe.

FIG. 2 depicts another perspective view of an embodiment of a safety valve apparatus with the valve lever in the open position.

FIG. 3 depicts another perspective view of an embodiment of a safety valve apparatus during activation.

FIG. 4 depicts another perspective view of an embodiment of a safety valve apparatus with the valve lever in the closed position.

FIG. 5 depicts a perspective view of another embodiment of a safety valve apparatus with the valve lever in the open position

FIG. 6 depicts another perspective view of another embodiment of a safety valve apparatus during activation.

FIG. 7 depicts another perspective view of another embodiment of a safety valve apparatus with the valve lever in the closed position.

FIG. 8 depicts a flow diagram of a method of installing an embodiment of a safety valve apparatus.

FIG. 9 depicts a flow diagram of another method of installing another embodiment of a safety valve apparatus.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention. It should be noted that there are many different and alternative configurations, devices, and technologies to which the disclosed inventions may be applied. The full scope of the inventions is not limited to the examples that are described below.

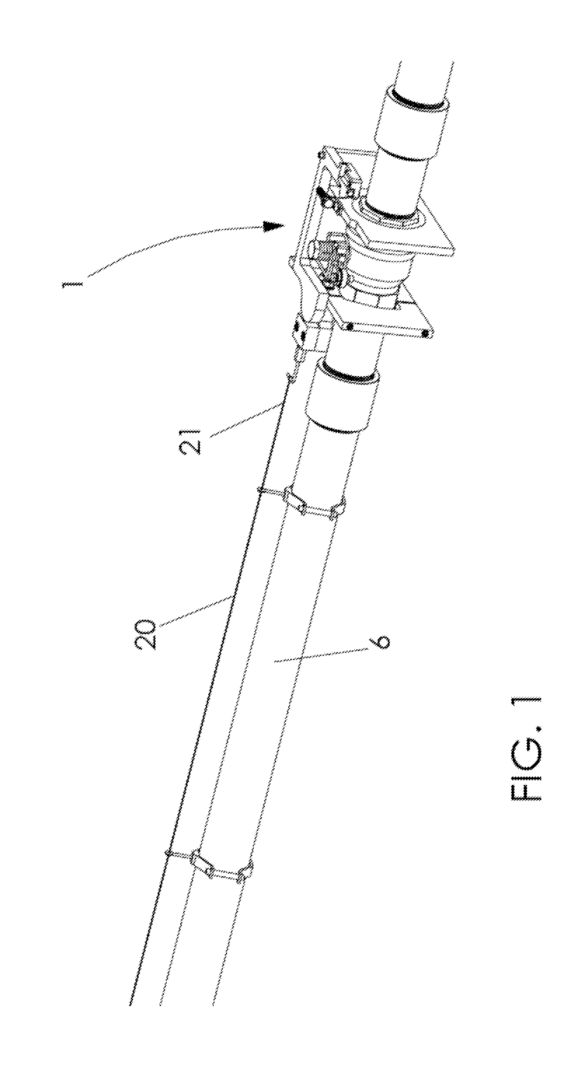

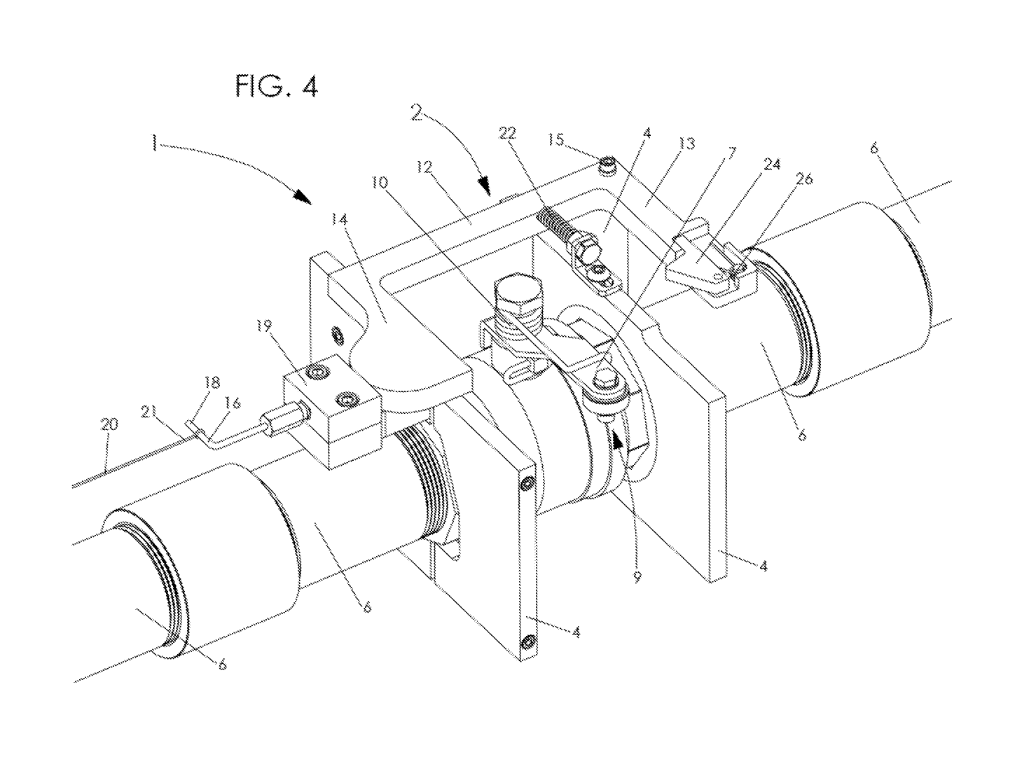

In the current embodiment of a safety valve apparatus 1, depicted in FIGS. 1-4, the safety valve apparatus 1 may comprise an apparatus foundation 4, a pipe 6, a valve lever 7, a shifting mechanism 10, a release bar 12, a release rod 16, and a nickel-titanium alloy wire 20. The apparatus foundation 4 and valve lever 7 may be coupled to the pipe 6. The release bar 12 may be coupled to the foundation 4, and removably-coupled to the valve lever 7. The shifting mechanism 10 may be coupled to the valve lever 7. The release rod 16 may be held in place by a rod holder 19, and the release rod 16 may be removably-coupled to the release bar 12. Finally, the nickel-titanium alloy wire 20 may be coupled to the release rod 16. The nickel-titanium alloy wire 20 is the actuator for the safety valve apparatus 1.

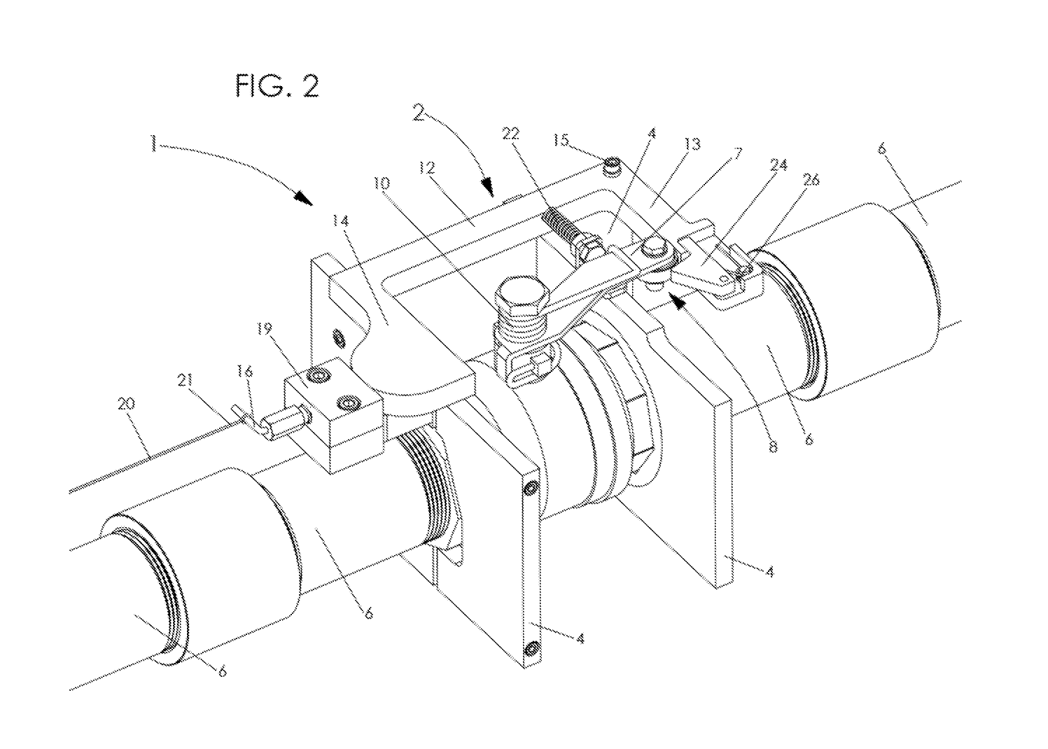

The foundation 4 may be the component of the safety valve apparatus 1 upon which other components of the safety valve apparatus 1 couple. As depicted in FIG. 2-4, the foundation 4 may be at least one rigid plate coupled vertically to the pipe 6 and extending in a direction perpendicular to the direction of travel of the pipe 6. The foundation 4 may further comprise additional rigid plates, which may be coupled to the pipe 6 or to existing rigid plates already making up the foundation 4. In other embodiments, the foundation 4 may be comprised of rigid plates mounted horizontally, parallel to the pipe 6, or be configured in any other orientation sufficient to allow the coupling of the other components of the safety valve apparatus 1 to it. The foundation 4 may also be blocks or other solid shapes of rigid material to which the other components of the safety valve apparatus 1 may couple. The foundation 4 may also be the pipe 6 itself; that is, the components of the safety valve apparatus 1 may couple directly to the pipe 6, which would be within the scope of the present invention.

The valve lever 7 controls the flow of liquid or gas through the pipe 6. The valve lever 7 may be in a completely open position 8 or a completely closed position 9, or any position in between completely opened or completely closed. Furthermore, the valve lever 7 may be a rotational device in which the amount of fluid or gas flow is determined by the amount the valve lever 7 is rotated, or it may be a flow control device that shifts along an axis. In the latter embodiment, the valve lever being positioned on the first end of the axis would constitute valve lever being in the completely open position, and the valve lever being positioned on the second end of the axis, opposite the first end, would constitute the completely closed position.

In the embodiment depicted in FIG. 1-4, the shifting mechanism 10 may couple to the valve lever 7, and cause the valve lever 7 to be biased to automatically move to the closed position 9 if there is no obstruction to doing so. Depending on the safety valve apparatus embodiment, the shifting mechanism 10 may cause the valve lever 7 to shift in a rotational manner as depicted in FIGS. 1-4, or it may cause the valve lever to shift along an axis. In the embodiment depicted in FIGS. 1-4, the shifting mechanism 10 is a clock spring, but it may be any torsional spring if the shifting motion of valve lever 7 is rotational, or any other mechanism to store potential energy until it is released into kinetic energy by activation of the safety valve apparatus 1. In an embodiment in which the valve lever is shifted along an axis, the shifting mechanism may be a traditional coil spring storing potential energy until activation of the safety valve apparatus or any other suitable mechanism.

The release bar 12 is the component of the safety valve apparatus 1 that may removably couple to the valve lever 7 when the valve lever 7 is in the open position 8, and may hold the valve lever 7 in the open position 8 against the bias of the shifting mechanism 10 to move the valve lever 7 to the closed position 9. The release bar 12 holding the valve lever 7 in the open position 8 may allow for the storing of potential energy created by the valve lever's bias to move into the closed position 9. The release bar 12 may be comprised of a first end 13, a second end 14 opposite the first end, and at least one mid point 15. In the current embodiment, the release bar 12 may be coupled to the foundation 4 (or the pipe 6) at the release bar midpoint 15, or any other suitable point on the release bar 12. In FIG. 1-4, the release bar 12 is U-shaped but may be any other suitable shape to hold the valve lever 7 in the open position 8. The valve lever 7, when in the open position 8, may removably-couple to the release bar first end 13. The release bar 12 may remain static despite the bias for the valve lever 7 to move into the closed position 9, because the release bar second end 14 may be removably-coupled to the release rod 16, and the release rod 16, which may be held in place by the rod holder 19, may not allow the release bar 12 to move. Upon activation, when the release rod 16 may decouple from the release bar second end 14 by shifting in a direction 27, the release bar 12 may be able to move and may rotate about the release bar midpoint 15, which may be coupled to the foundation 4 (which could be the pipe 6 itself), in a direction 29, or shift along an axis, which may release the valve lever 7 to move to the closed position 9.

The release rod 16 may be held in place by the rod holder 19, and in the current embodiment, the rod holder 19 may be coupled to the pipe 6, but also may be coupled to a foundation 4 (again, the pipe 6 may be considered a foundation). The rod holder 19 may be any rigid object holding the release rod 16 in place against the potential energy stored by the release bar 12, the valve lever 7 in the open position 8, and the shifting mechanism 10. The release rod 16 may comprise a release rod first end 17, which is removably-coupled to the release bar second end 14, and a release rod second end 18 opposite the release rod first end 17. The release rod 16 may be a cylinder, a cube or rectangle, a flat plate, or any suitable shape such that the release rod 16 in the rod holder 19 holds the release bar 12 from moving despite the force applied to the release bar 12 from the bias of the valve lever 7 to move to the closed position 9. The release rod 16 may couple to the release bar second end 14 at any point whether the coupling take place on the edge of the release bar second end 14, or at a point on the release bar second end 14 that is closer along the release bar 12 to the release bar first end 13. In alternative embodiments, the release rod may be coupled to other parts of the release bar, such as the release bar first end or a midpoint, without going outside the scope of this invention. As long as the release rod is coupled to the release bar such that it prevents the release bar from shifting without activation of the safety valve apparatus, the design is within the scope of this invention.

The actuator of the safety valve apparatus 1 is the nickel-titanium alloy wire 20. The wire 20 may be comprised of any mixture of nickel and titanium so that the wire 20 has a negative coefficient of thermal expansion. That is, the wire 20 contracts when heated, which is opposite to ordinary thermal expansion. The wire 20, in the current embodiment, may comprise a distal end 21 that may couple to the release rod second end 18, so that when the wire 20 is heated by a fire, for example, and contracts, it may pull on the release rod 16, decoupling the release rod 16 from the release bar 12, allowing activation of the safety valve apparatus 1 and the automatic turning of the valve lever 7 to the closed position 9. The wire 20 may travel along the pipe 6 in a direction away from the safety valve apparatus 1, and may be substantially parallel to or slanted relative to the pipe 6, wherein the wire has tension and is taught along the pipe 6. The wire 20 may be oriented above, below, on the side of, spiraling around the pipe 6 in a helical fashion, or any other orientation along the pipe 6 so that the wire 20 is in a position to detect excess heat or fire along the pipe 6 and has enough tension so it can activate the safety valve apparatus 1 to move the valve lever 7 to the closed position 9. Having the wire 20 span great lengths along the pipe 6 allows the safety valve apparatus 1 to have wide-ranging fire detection capabilities with its mechanical design.

The safety valve apparatus 1 may have a protective casing around it (not pictured) to protect the safety valve apparatus 1 from external forces that may compromise its reliability. The protective casing may be of any shape which would enclose the safety valve apparatus 1, such as of a rectangular, spherical, cylindrical, etc. shape. It may be clear, translucent, or opaque and may be comprised of any material rigid enough to protect the safety valve apparatus 1 from external forces. The protective casing may have a hole to allow the wire 20 to extend outside the protective casing along the pipe 6. The protective casing may also allow access to the safety valve apparatus 1 by having two parts of the protective casing attached by a hinge, creating a door, of sorts, to the inside of the protective casing, or may be comprised of separate parts that can be disassembled.

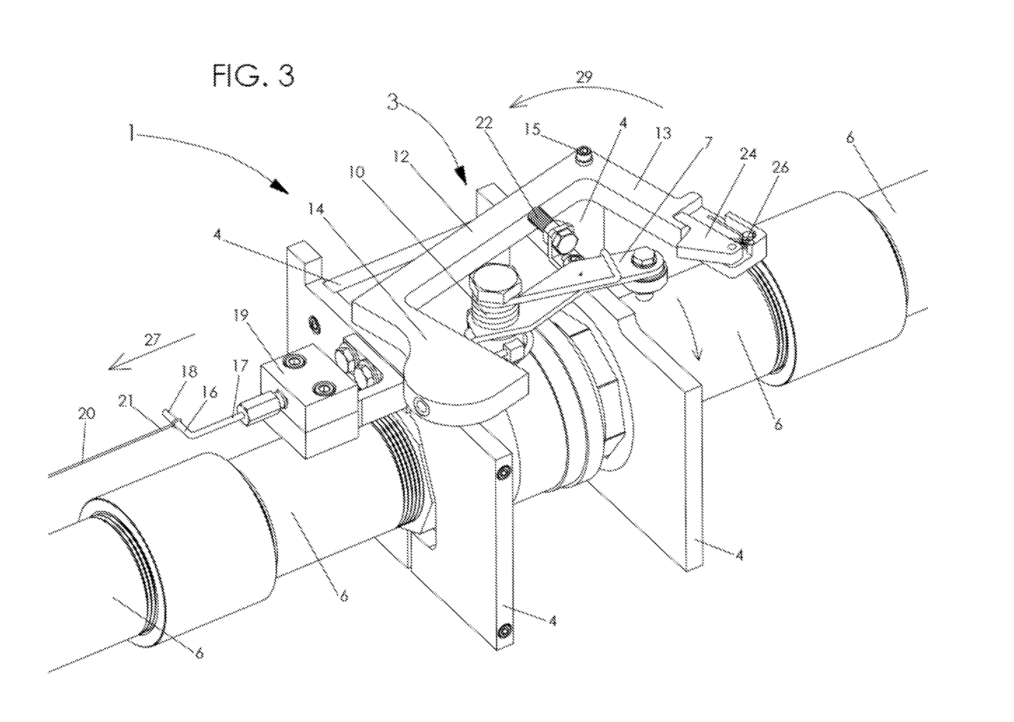

The safety valve apparatus 1 may further comprise a reset mechanism 22 which may be coupled to the foundation 4 or the pipe 6. The reset mechanism 22, may be a spring, which has a bias to keep the release bar 12 in its pre-activation position 2. In the current embodiment, when the safety valve apparatus 1 is activated, the release bar 12 may rotate in the direction 29 as the valve lever 7 automatically moves to the closed position 9. The activation position of release bar 12 may be the release bar activation position 3, shown in FIG. 3. The release bar activation position 3 may cause the reset mechanism 22 to have stored potential energy, which may be released into kinetic energy when the valve lever 7 has moved into the closed position 9, and the reset mechanism 22 may force the release bar 12 back into its pre-activation position 2.

The safety valve apparatus 1 may further comprise a reset cap 24 coupled to the release bar first end 13. In embodiments comprising the reset cap 24, the reset cap 24 may be the part of the release bar first end 13 that holds the valve lever 7 in the open position 8. When the valve lever 7 has been moved to the closed position 9, in order to manually reset the valve lever 7 to the open position 8, without the reset cap 24, one would have to shift the entire reset bar 12, against the bias of the reset mechanism 22. However, with the reset cap 24, the release bar 12 can remain in its pre-activation position 2, and as the valve lever 7 is returned into the open position 8, it contacts the reset cap 24, the reset cap 24 shifts out of the valve lever's 7 way, until the valve lever 7 reaches the open position 8, at which point a spring 26 may return the reset cap 24 to its original position in which it holds the valve lever 7 in its open position 8. The spring 26 maybe any device suitable to return the reset cap 24 to its original position, in which the reset cap 24 is configured to hold the valve lever 7 in its open position 8.

FIG. 3 depicts the safety valve apparatus 1 during activation, in which the release bar 12 may be in its activation position 3. When the wire 20 is heated (because of the detection of a fire, for example), it contracts, and may shift the release rod 16 in the direction 27, decoupling the release rod first end 17 from the release bar 12. With the release rod 16 no longer holding the release bar 12 in place, the valve lever 7 may then be able to automatically move to the closed position 9 by releasing the potential energy stored by the shifting mechanism 10. As the valve lever 7 moves to its closed position 9, the release bar 12 may shift about its midpoint 15 in the direction 29, moving out of the way of the valve lever 7. Once the valve lever 7 has reached its closed position 9, the reset mechanism 22 then may shift the release bar 12 back into its pre-activation position 2. The valve lever 7 then may manually be moved back into its open position 8 easily because of the addition of the reset cap 24, as described above.

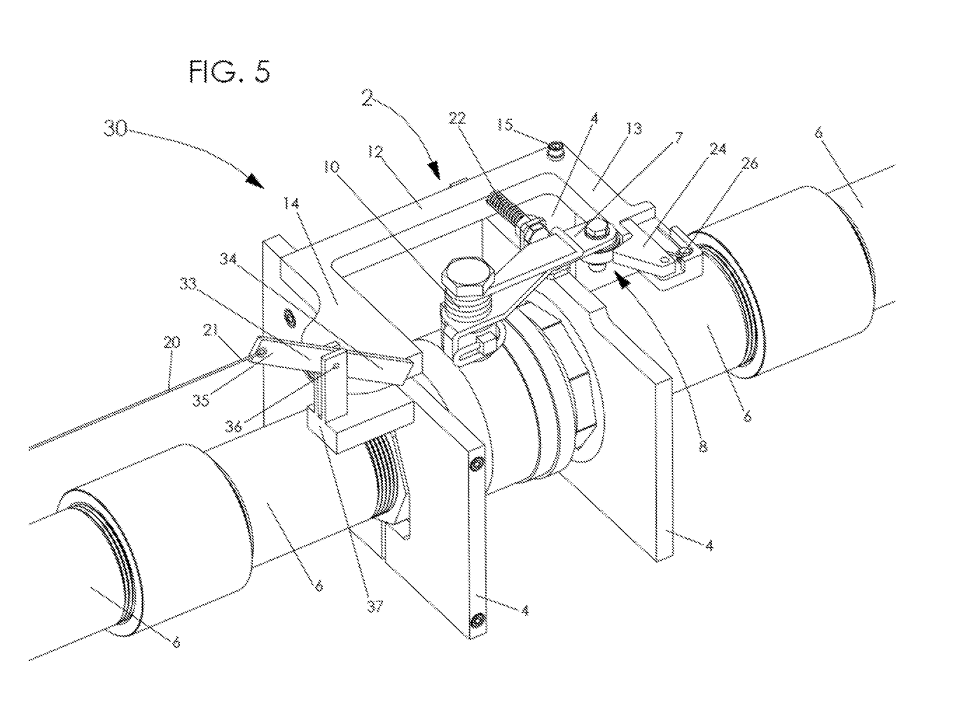

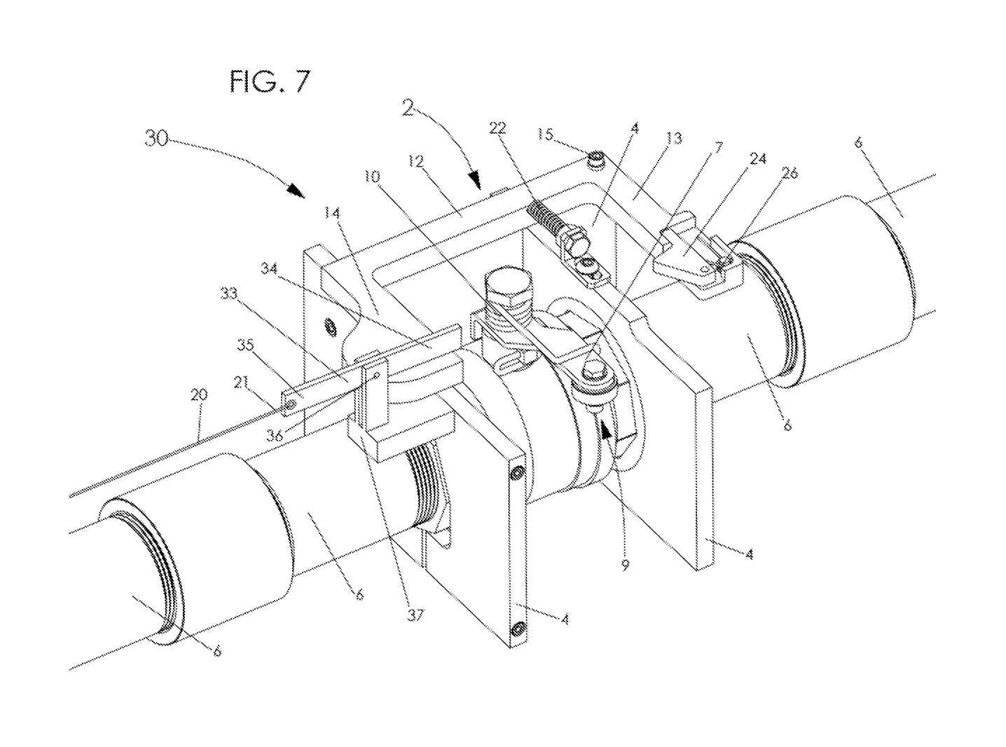

In another embodiment of the safety valve apparatus, depicted in FIGS. 5-7, a safety valve apparatus 30 may comprise one or more of the same components in the safety valve apparatus 1, as described above and depicted in FIGS. 1-4, except instead of a release rod 16, there may be a release lever 33. The release lever 33 may comprise a release lever first end 34, which may be removably-coupled to the release bar second end 14, a release lever second end 35, which may be coupled to the wire distal end 21, and a release lever midpoint 36, which may be coupled to a fulcrum 37. The release lever midpoint 36 may be on any suitable point along the release lever 33. The fulcrum 37 may be coupled to the foundation 4 or the pipe 6. In this embodiment, the release lever 33 may be what keeps the release bar 12 in its pre-activation position 2 while the valve lever 7 is in the open position 8. The release lever 33 may be rotatable on a vertical plane (depicted), a horizontal plane, or any other suitably-oriented plane that would allow the release lever 33 to removably-couple with the release bar second end 14, and then decouple to allow the safety valve apparatus 30 to activate. The release lever first end 34 may couple with the release bar second end 14, release bar first end 13, or a release bar midpoint 15 (though it does not have to be the specific midpoint 15 as depicted in the figures) as long as the configuration would allow the release lever 33 to couple with the release bar 12, and then decouple to allow the safety valve apparatus 30 to activate.

Activation of the safety valve apparatus 30 may comprise the wire 20 being heated and contracting, causing force to be applied to the release lever second end 35. The release lever 33 may then shift about the fulcrum 37, in a direction 28, as a result of the force from the wire 20 being applied to the release lever second end 35, which may cause the release lever first end 34 to be decoupled from the release bar second end 14. With the release lever 33 no longer holding the release bar 12 in place, the valve lever 7 may then be able to automatically move to the closed position 9 by releasing the potential energy stored by the shifting mechanism 10. As the valve lever 7 moves to its closed position 9, the release bar 12 may shift about its midpoint 15 in the direction 29, moving out of the way of the valve lever 7. Once the valve lever 7 has reached its closed position 9, the reset mechanism 22, may then shift the release bar 12 back into its pre-activation position 2. The valve lever 7 may manually be moved back into its open position 8 easily because of the addition of the reset cap 24, as described above.

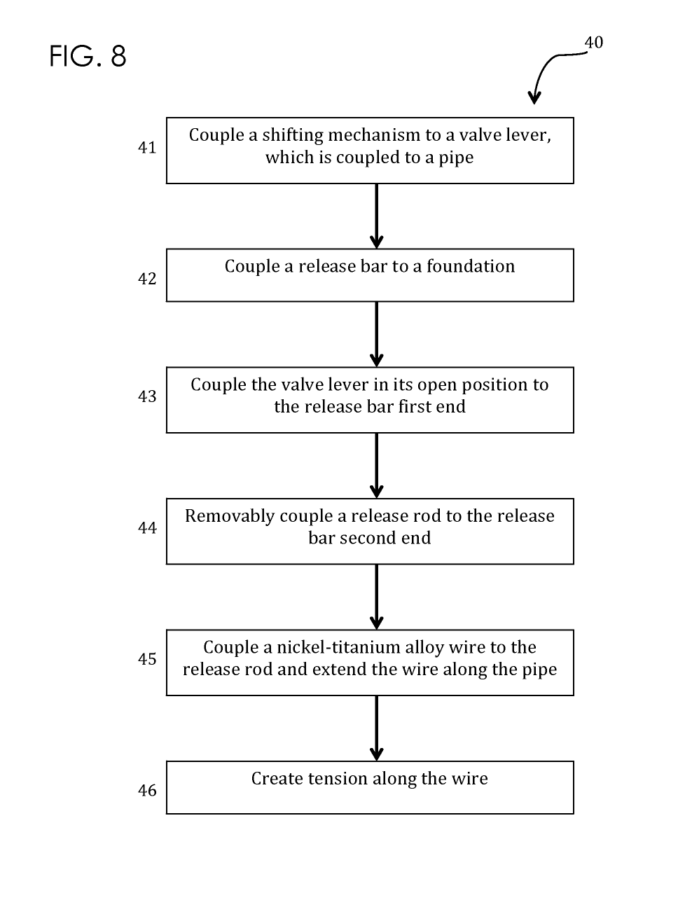

FIG. 8 depicts a flow diagram of a method 40 for installing the safety valve apparatus 1. Block 41 describes a step comprising coupling a shifting mechanism to a valve lever, which is coupled to a pipe. The shifting mechanism causes the valve lever to be biased to automatically move into the closed position, such as a torsional spring or clock spring for a rotational valve lever. Another step, described in block 42, comprises coupling a release bar to a foundation. The foundation may be any sturdy structure to support the release bar and other components of the safety valve apparatus, and may be the pipe itself. The release bar may be coupled to the foundation by any type of suitable fastener. Then, block 43 describes a step comprising coupling the valve lever, in its open position, to a first end of the release bar. A second end of the release bar is then removably coupled to a release rod, as described in block 44, wherein the release rod holds the release bar in place, so the release bar is able to hold the valve lever in its open position despite its bias to move to the closed position. Then, block 45 describes a step comprising coupling nickel-titanium wire to the release rod, and extending the wire along the pipe. Finally, create tension along the wire, as described in block 46. If there is a fire and the wire is heated and contracts, the tension in the wire will allow the wire to pull the release rod, decoupling it from the release bar, which will release the valve lever to automatically move to the closed position. These steps may be performed in any suitable order to install the safety valve apparatus 1.

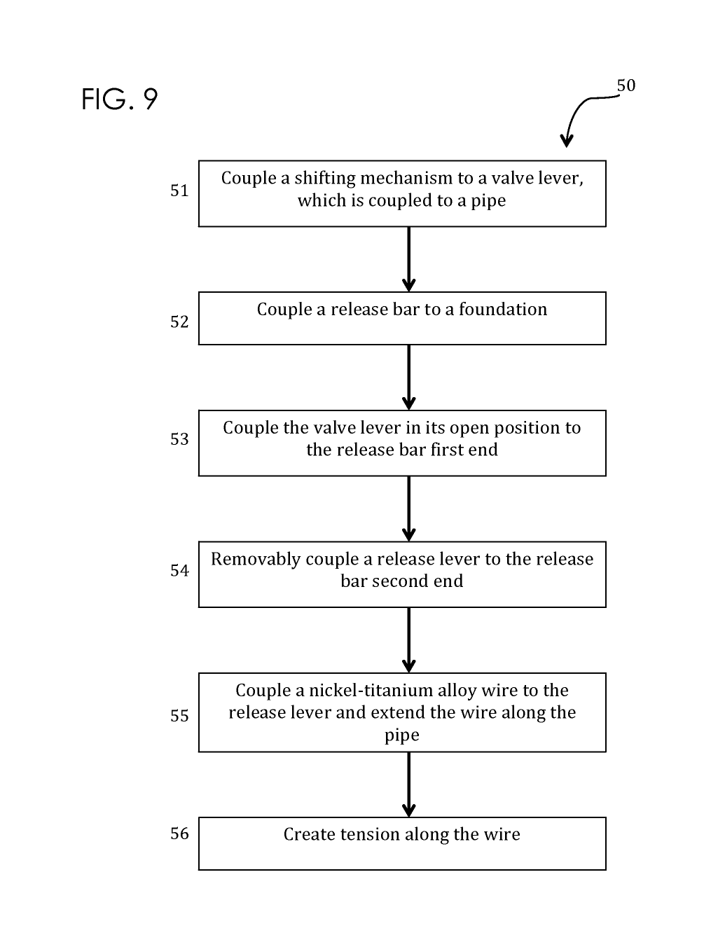

FIG. 9 depicts a flow diagram of a method 50 for installing the safety valve apparatus 30. Block 51 describes a step comprising coupling a shifting mechanism to a valve lever, which is coupled to a pipe. The shifting mechanism causes the valve lever to be biased to automatically move into the closed position, such as a torsional spring or clock spring for a rotational valve lever. Another step, described in block 52 comprises coupling a release bar to a foundation. The foundation may be any sturdy structure to support the release bar and other components of a safety valve apparatus, and may be the pipe itself. The release bar may be coupled to the foundation by any type of suitable fastener. Then, block 53 describes a step comprising coupling the valve lever, in its open position, to a first end of the release bar. A second end of the release bar is then removably coupled to a release lever, as described in block 54, wherein the release lever holds the release bar in place, so the release bar is able to hold the valve lever in its open position despite its bias to move to the closed position. Then, block 55 describes a step comprising coupling nickel-titanium wire to the release lever, and extending the wire along the pipe. Finally, create tension along the wire, as described in block 56. If there is a fire and the wire is heated and contracts, the tension in the wire will allow the wire to put force on the release lever, shifting and decoupling it from the release bar, which will release the valve lever to automatically move to the closed position. These steps may be performed in any suitable order to install the safety valve apparatus 30.

In other embodiments, the safety valve apparatus may take on different configurations of components, which would not be outside the scope of this invention. Some components may be added or removed, and/or existing components may be changed in their structure or interaction with other components of the safety valve apparatus. For example, the release bar 12 may take on different configurations such as an L-shape, or a straight bar along one axis.

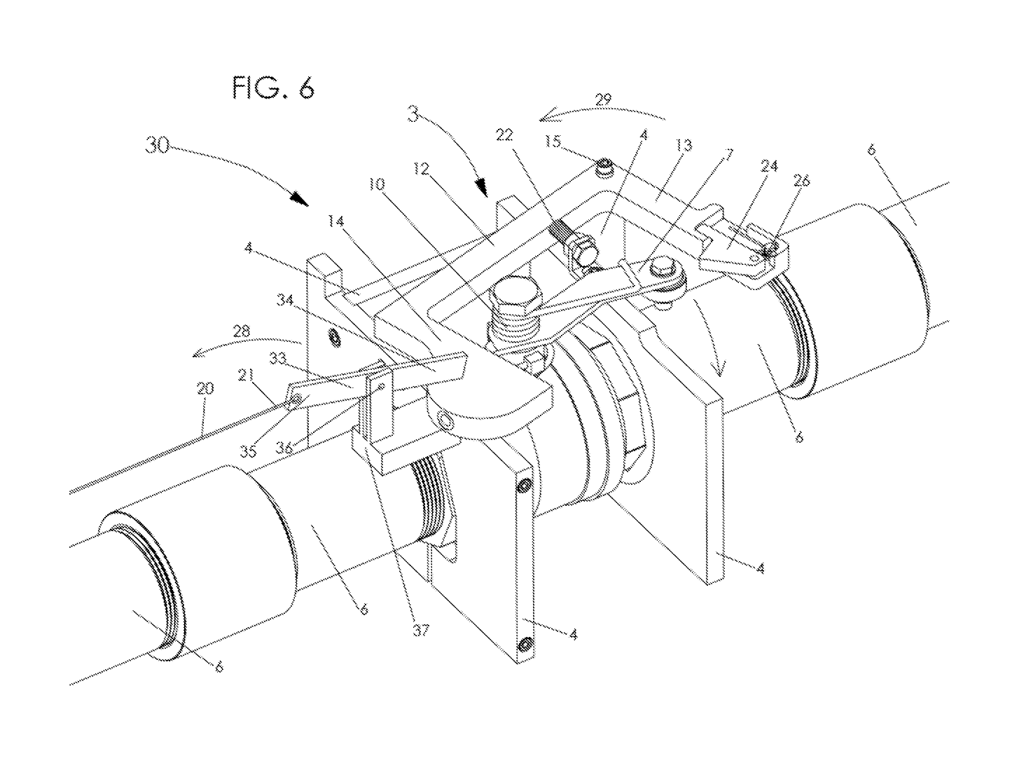

In other embodiments, the wire 20 may be directly coupled to the release bar 12, anywhere on the release bar 12. That way, when heat causes the wire 20 to contract, the wire puts force on the release bar 12 directly, causing the release bar 12 to rotate about some midpoint (like the embodiment in FIGS. 3 and 6), or causing the release bar 12 to shift along an axis; either way, in this embodiment, the wire 20 would directly cause the release bar to shift out of the way of the valve lever 7, so the valve lever 7 could move into the closed position 9. In the embodiments in which the wire 20 is directly coupled to the release bar 12, in order for the force from the wire 20 to come from the correct direction on the release bar 20, there may need to be at least one pulley for the wire 20 to travel along. For example, if the motion of the release bar 12 in FIG. 3, in direction 29, were desired, but the wire 20 was directly coupled to the release bar 12, the wire 20 would have to come in contact with the release bar second end 14 from a direction perpendicular to the pipe 6. Accordingly, a pulley may receive the wire 20 as it came toward the safety valve apparatus 1 parallel to the pipe 6, and then send the wire 20 to couple with the release bar 12 in a direction perpendicular to the pipe 6.

In other embodiments, the wire 20 may come directly in contact with the valve lever 7. In these embodiments, when the wire 20 contracts as a result of being heated, the force caused by the contracting wire 20 on the valve lever 7 may cause the valve lever 7 to move to the closed position 9. This embodiment may also call for the wire 20 coming from a direction other than parallel to the direction of the pipe 6. Therefore, having the wire 20 travel along a pulley in the safety valve apparatus may allow the wire 20 to couple with the valve lever 7 from a direction that would be appropriate to shift the valve lever 7 to the closed position 9 when the wire 20 contracts and the safety valve apparatus is activated.

We claim:

1. A valve apparatus, comprising:
a valve lever coupled to a pipe;
a release bar comprising:
a first end removably coupled to the valve lever configured to hold the valve lever in an open position;
a second end; and
a mid-point, at which the release bar is moveably-coupled to a foundation;
a shifting mechanism coupled to the valve lever and configured to automatically move the valve lever to a closed position when the first end of the release bar is decoupled from the valve lever;
a release rod, wherein the release rod is held in place by a rod holder, the release rod comprising:
a first end removably-coupled to the second end of the release bar; and
a second end; and
a nickel-titanium alloy wire comprising a distal end that is coupled to the second end of the release rod, wherein the wire extends away from the valve apparatus along the pipe in a direction opposite the wire distal end.

2. The apparatus of claim 1, further comprising a protective casing enclosing the valve apparatus.

3. The apparatus of claim 1, further comprising a reset mechanism to reset the release bar to a pre-activation position after activation of the valve apparatus.

4. The apparatus of claim 1, wherein the release bar is U-shaped.

5. The apparatus of claim 1, further comprising a reset cap coupled to the first end of the release bar, wherein the reset cap holds the valve lever in the open position before activation of the valve apparatus.

6. The apparatus of claim 5, further comprising a spring adjacent to the reset cap to return the reset cap to an original position if moved.

7. The apparatus of claim 1, wherein the foundation to which the release bar is coupled, is the pipe.

8. A method of installing a heat-actuated safety valve apparatus, comprising:
coupling a release bar, comprised of a first end and a second end, to a foundation;
removably coupling a valve lever, which is coupled to a pipe, in an open position, to the first end of the release bar;
coupling a shifting mechanism to the valve lever;
removably coupling a release rod to the second end of the release bar, wherein the release rod is held in place by a rod holder;
coupling nickel-titanium alloy wire to the release rod, wherein the wire extends along the pipe; and
creating tension along the nickel-titanium alloy wire, wherein such tension, when heated, will cause the nickel-titanium alloy wire to contract and pull the release rod coupled to the wire, decoupling the release rod from the release bar, and activating the safety valve apparatus.

9. The method of claim 8, further comprising a step of coupling a reset cap to the release bar, which holds the valve lever in the open position before activation of the valve apparatus.

10. The method of claim 9, further comprising a step of coupling a spring adjacent to the reset cap.

11. The method of claim 8, wherein the release bar is U-shaped.

12. The method of claim 8, further comprising coupling a reset mechanism to the release bar and the foundation.

13. The method of claim 8, further comprising coupling a protective casing around the safety valve apparatus.

14. A valve apparatus, comprising:
a valve lever coupled to a pipe;
a release bar comprising:
a first end removably coupled to the valve lever configured to hold the valve lever in an open position;
a second end; and
a mid-point, at which the release bar is moveably-coupled to a foundation;
a shifting mechanism coupled to the valve lever and configured to automatically move the valve lever to a closed position when the first end of the release bar is decoupled from the valve lever;
a release lever, wherein the release lever is held in place by a fulcrum, the release lever comprising:
a first end removably-coupled to the second end of the release bar; and
a second end; and
a nickel-titanium alloy wire comprising a distal end that is coupled to the second end of the release lever, wherein the wire extends away from the valve apparatus along the pipe in a direction opposite the wire distal end.

15. The apparatus of claim 14, further comprising a protective casing enclosing the valve apparatus.

16. The apparatus of claim 14, further comprising a reset mechanism to reset the release bar to a pre-activation position after activation of the valve apparatus.

17. The apparatus of claim 14, wherein the release bar is U-shaped.

18. The apparatus of claim 14, further comprising a reset cap coupled to the first end of the release bar, wherein the reset cap holds the valve lever in the open position before activation of the valve apparatus.

19. The apparatus of claim 18, further comprising a spring adjacent to the reset cap to return the reset cap to an original position if moved.

20. The apparatus of claim 14, wherein the foundation to which the release bar is coupled, is the pipe.
